(19) United States
(12) Patent Application Publication
(10) Pub. No.: US 2009/0307141 A1
(43) Pub. Date: Dec. 10, 2009

(54) Secure Card Services

(75) Inventors: George Philip Kongalath, St-Laurent (CA); Anna Anthony, St- Laurent (CA); Mathieu Benoit, Stockholm (SE); Ravi Gattu, Haninge (SE); Kaveh Piroozram, Varby (SE)

Correspondence Address: POTOMAC PATENT GROUP PLLC, P. O. BOX 270, FREDERICKSBURG, VA, 22404, US

(73) Assignee: Telefonaktiebolaget LM Ericsson (publ), Stockholm (SE)

(21) Appl. No.: 12/260,480

(22) Filed: Oct. 29, 2008

Related U.S. Application Data
(63) Continuation of application No. 61/059,402, filed on Jun. 6, 2008.

(51) Int. Cl. G07F 7/12

(52) U.S. Cl. 705/72; 235/382; 235/379; 705/44

(57) ABSTRACT

Methods and systems are provided to increase the security of a user's information as well as perform secure transactions. More particularly, in one exemplary embodiment, a user inputs information into a database which enables or disables information which may be requested by a third party establishment. In another exemplary embodiment, location based transaction authentication is used.

### RELATED APPLICATION

This application is related to, and claims priority from, U.S. Provisional Patent Application Ser. No. 61/059,402, filed on Jun. 6, 2008, entitled “Secure Card Services”, the disclosure of which is incorporated here by reference.

### TECHNICAL FIELD

The present invention generally relates to systems, devices, software and methods and, more particularly, to mechanisms and techniques for protecting identity data for performing secure transactions.

### BACKGROUND

Credit card fraud and identity theft are serious problems today. There are currently limited ways available for a user to restrict credit card usage, or to restrict the use of one's identity data. As a result, individuals may be faced with unpleasant surprises where they find themselves in situations where others have run up massive debts in their names.

Today's technology is limited when it comes to protecting identity data. Shredders have seen a sharp increase in sales as individuals resort to shredding paper that has any links to their identity or credit history. Bureaus issuing identity documents are making it a bit more difficult for identity thieves to obtain this information by mailing documents to one's home. While all of these elements raise the bar against such illegal activities, they have still done little more than slow down the rapidly increasing crimes associated with identity theft and credit card fraud.

In this context, when a credit card transaction occurs, for example, it may be difficult or impossible to determine whether the transaction authorized is a bona fide transaction or a fraudulent transaction. If the transaction turns out to be a fraudulent transaction, it can lead to a long and expensive path for the owner of the credit card to prove that it was a fraudulent transaction. The Internet has opened the world of commerce and instant trade. However, fraud has made many end-users very wary of using credit cards (and other personal information) on the Internet. One example of fraudulent use that can occur is when new documents are created related to an end-user without the end user's realization of what has been created which can result in financial hardship for the end user.

In many economies the social insurance number, a personal number, or other government issued identity to end users, is part of the basis for a business to perform business transactions with people. Since this personal identifier can be used for a variety of business transactions (and is often either the only information needed or it easily leads to other personal identification information), when this personal identifier is stolen it becomes easier for people, e.g., hackers, to perform fraudulent activities, e.g., obtaining a new credit card, taking out a loan, registering and transferring real-estate and buying a car in the name (or names) other than their own. One proposed solution to securing this personal identification information to reduce fraud is where credit card companies put a chip on a credit or debit card so that the chip generates a hash to secure communications.

While chips on cards can improve security to some degree, there are many negatives associated with this solution. For example, when a user is travelling and a suspected illegal usage of the credit card results in the cancellation of the card, the user is penalized by being left in a potentially difficult situation since, when travelling, the only form of payment a traveler often has is his or her credit card. Additionally, chip card readers can be tampered with, as a result the digital hash that is produced in response to transaction details may not reflect the actual approval. Therefore, the chip on a credit card makes it in no way certain that one's transaction is being approved correctly, or that prevents a transaction from being sent to a card in a fraudulent manner.

Accordingly, it would be desirable to provide devices, systems and methods for protecting identity data which avoid the afore-described problems and drawbacks.

### SUMMARY

The following exemplary embodiments provide a number of advantages and benefits relative to protecting identity data and for performing transactions. According to an exemplary embodiment, a method for validating a current transaction includes: storing information indicating that transactions associated with a secure transaction instrument are disabled for at least one of: (a) a predetermined period of time, (b) a particular type of transaction, (c) a predetermined geographical location and (d) transactions which exceed a predetermined amount; receiving an inquiry via a validation Uniform Resource Identifier (URI) regarding the current transaction associated with the secure transaction instrument; determining whether the current transaction shall be authenticated based upon a comparison of information associated with the inquiry to the stored information; and transmitting an authentication signal.

According to another exemplary embodiment, a device for validating a current transaction includes: a memory for storing information indicating that transactions associated with a secure transaction instrument are disabled for at least one of: (a) a predetermined period of time, (b) a particular type of transaction, (c) a predetermined geographical location and (d) transactions which exceed a predetermined amount; an input circuitry for receiving an inquiry via a validation Uniform Resource Identifier (URI) regarding the current transaction associated with the secure transaction instrument; a processor for determining whether the current transaction shall be authenticated based upon a comparison of information associated with the inquiry to the stored information; and an output circuitry for transmitting an authentication signal.

According to another exemplary embodiment, a method for establishing validation parameters for a secure transaction instrument includes: transmitting, from an end user device, information indicating that the secure transaction instrument shall be disabled for at least one of: (a) a predetermined period of time, (b) a particular type of transaction to a trustee database server, (c) a predetermined geographical location and (d) transactions which exceed a predetermined amount.

According to another exemplary embodiment, a device for establishing validation parameters for a secure transaction instrument includes: an output circuitry for transmitting, from an end user device, information indicating that the secure transaction instrument shall be disabled for at least one of: (a) a predetermined period of time, (b) a particular type of transaction to a trustee database server, (c) a predetermined geographical location and (d) transactions which exceed a predetermined amount.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows an Internet Protocol Multimedia Subsystem (IMS) architecture;

FIG. 2(a) shows a user interfacing with a trustee database according to exemplary embodiments;

FIG. 2(b) illustrates a user giving vendors Uniform Resource Identifier (URI) link information according to exemplary embodiments;

FIG. 3 depicts a signaling diagram for an establishment device to determine authorization of a request according to exemplary embodiments;

FIGS. 4 and 5 illustrate IMS implementations according to exemplary embodiments;

FIG. 6 is a schematic diagram of a device used by a user or an establishment according to exemplary embodiments;

FIG. 7 is a schematic diagram of a server according to an exemplary embodiment; and

FIG. 8 is a method flow chart according to exemplary embodiments.

### DETAILED DESCRIPTION

The following description of the exemplary embodiments refers to the accompanying drawings. The same reference numbers in different drawings identify the same or similar elements. The following detailed description does not limit the invention. The following embodiments are discussed, for simplicity, with regard to the terminology and structure of communication systems described below. However, the embodiments to be discussed next are not limited to these systems but may be applied to other existing communication systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

One problem associated with existing credit card fraud solutions is that users typically have no method to control transactions when their identity, credit cards or debit cards, etc. are used. Historically, some security was available by “brick and mortar” vendors requiring that a user physically possessed the credit card in order to make a purchase. However with the advent of the Internet even this limited security mechanism is no longer available for some transactions. Thus, according to exemplary embodiments, individuals can enable or disable the use of their cards (or identities), e.g., for a period of time when they don't plan to use such cards or identities. When the card or identity is enabled, a transaction can proceed, otherwise if it is disabled, the transaction cannot proceed.

For instance, according to one exemplary embodiment, when an individual wishes to perform a transaction using a card or trustee element, the individual enables that card or trustee element for transactions by contacting a directory which stores all of his or her desired stored information regarding enabling or disabling a stored item. The enable period can be for a single transaction, multiple transactions over time, transactions for a given vendor over time, or a geographical limitation, e.g., cards are only good in Boston or in the view of a certain base station, and the like. Trustee elements can include any type of information that a person uses, but wishes to keep safe. For example, trustee information can include, but is not limited to, credit cards, debit cards, passports, social insurance numbers, loan information, information used for registering and transferring real estate and stocks, alarm enablement/disablement, access information to safe deposit boxes and any other information which can be used to authorize some type of transaction by the user.

When a company or device receives a transaction request which uses that person's card or identity to facilitate the transaction, the company, server or point of sale (POS) device looks up the verification Uniform Resource Identifier (URI) for the user and contacts the directory. A URI, e.g., a string of characters used to identify a resource on a network such as the Internet, and allow interaction with the identified resource. The POS device then contacts the URI and one of three process paths may be followed. Firstly, the process can check to determine if the card or identity is enabled for that transaction (this could be in degrees—always enabled, always disabled, enabled for a transaction, enabled for a transaction in a geographic location, enabled for an amount, etc.). If it is enabled for the transaction of interest, then the company may selectively accept the transaction based, e.g., on its own criteria that does not necessarily relate to the end-user in every transaction. If not enabled, the transaction is rejected.

Secondly, the process checks to see if the card or identity is enabled for that particular transaction as in the first path and, if it is, contact the user to get an approval else the transaction is rejected. Thirdly, the process can ask the entity available at the URI for approval—which involves the trustee checking on the enabled/disabled status of the instrument, and if enabled contacts the end user for a real-time approval else it is rejected. If the approval is received, the transaction can be allowed to proceed to the next phase, however, if the transaction is denied, then the transaction typically proceeds to a fault handling process which will generally result in a failed transaction.

As described above, an individual can either enable or disable a credit card or trustee element, e.g., passports, security codes for buildings, banks or safe deposit boxes, alarms or any other personal information that can be requested which the user has stored in a trustee database. According to one exemplary embodiment, the preferred link to the trustee database is a Session Initiation Protocol (SIP) URI. Alternatively, methods that electronically, physically, or through other mechanisms contact the trustee database may also be used.

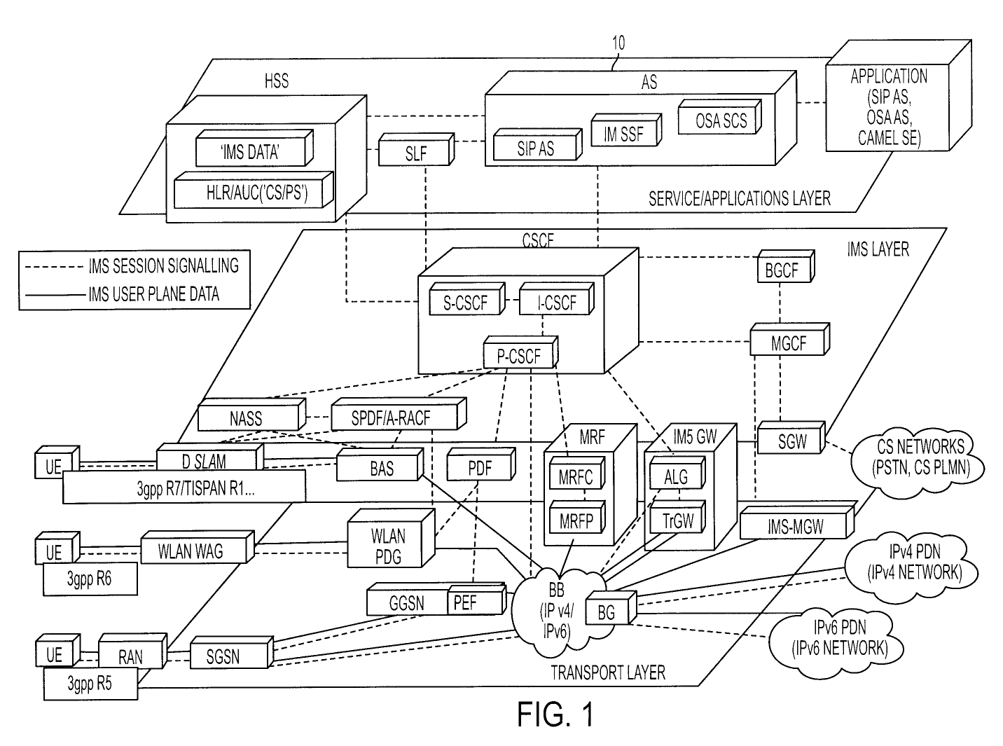

As mentioned above, the preferred link to the trustee database is through a SIP URI. Additionally, SIP messages may be used for other parts of the communication process which typically occur over an Internet Protocol Multimedia Subsystem (IMS) architecture an example of which is shown in FIG. 1. IMS offers increased security over other architectures because all points (nodes) are known and can have a secure identification. Also IMS is able to protect traffic between these points. FIG. 1 is described in the 3GPP TS 23.002 specification which is incorporated herein by reference.

Regarding the status of items in the trustee database as either being enabled or disabled, the status can be stored as plain text or as encrypted data. The time for enabling/disabling a given item, e.g., a credit card, can be stored within the encrypted text so as to reduce the risk of hackers determining the time when a card, or other stored trustee information, is enabled. However, when one leaves the status open regarding the time, hackers may be able to determine user behavior which needs to be avoided since it could provide an opening through which unauthorized persons could get access to a user's personal information. To reduce the chance that hackers may be able to determine user behavior, a new function describing using two layers of encryption is introduced as shown below in equation (1).

Fenc1(Fenc(Data text)+padding)=K (1)

Equation (1) is shown as having two levels of encryption. The first layer encrypts the status to be an encrypted string. The second level encrypts the encrypted string and generates an output of a constant K. This approach is useful and difficult to decrypt for various reasons. Initially, since the visible status regarding an item never changes, there is no indication for a hacker to see a change in the status of an item and hence no easy way to determine a user's behavior regarding the associated item. Additionally, there are two levels of encryption to break through as well as the added precaution of storing the first layer of encryption's table in one location, e.g., a data terminal, application server, ISIM or the like, and the second layer of encryption's table in a key table in a second different location, e.g., the host system where an authorization server and the database which stores the user's personal information reside for protecting a user's personal information. The second level of encryption which generates an output of a constant K, is typically used for enablement fields, however, according to exemplary embodiments, it can be used for any set of data that is sensitive and not usable by hackers at the interface access.

According to exemplary embodiments, two methods are proposed for locating user data and decision making logic. In the first method, both the user data, in the form of a directory, and the logic is present at a clearing house. In the second method, the user data (possibly in a directory format) and logic are both present on an application server. Exemplary embodiments described below can typically be used for either method, but will typically be described from the point of view of an application server(such as the application server (AS) 10 shown in FIG. 1).

According to exemplary embodiments, a directory of cards, (e.g., credit, debit, identity information), on an application server associated with a user is provided which are registered in a trustee database. Since the purpose of the application server is to operate as a clearing house to enable/disable the cards from being involved in transactions, the cards can be identified in the directory using a subset of their complete identification information. For example, a person's MasterCard could be identified without using any of the 12 digits of the account number but instead merely by identifying the user and referring, e.g., to his or her MasterCard. In the event that a person owns more than one of the same type of instrument, e.g., two or more MasterCard cards, then the last 3 digits, and the issuing bank suffices to identify the card. The issuing bank is referenced by the first four digits. As another example, a user can set up their data in a directory by using data that is not usable to construct a transaction, e.g., reference information to a MasterCard from Barclays London and the last three digits 123. A bank may have more than one issuance code (four digit sequence)—in which case the issuance code is translated to a bank name. This provides a useful alternative to a solution requiring end users to enter all of their details, e.g., the entire credit card number. This also implies that the database is secure from hackers—as the data contained cannot be used for fraudulent transactions since it is sufficiently incomplete to be used for such purposes. Optimally, the database is managed exclusively by the end-user with the instrument verification URI provided by the user to card companies, identity issuers and companies having accounts with individuals or businesses as desired.

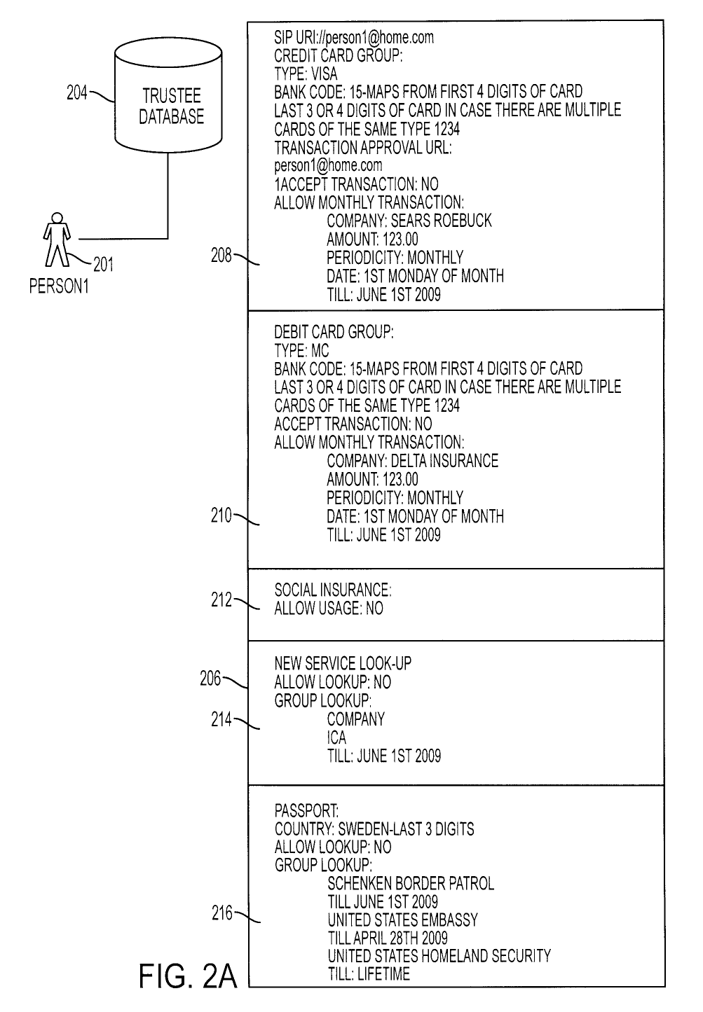

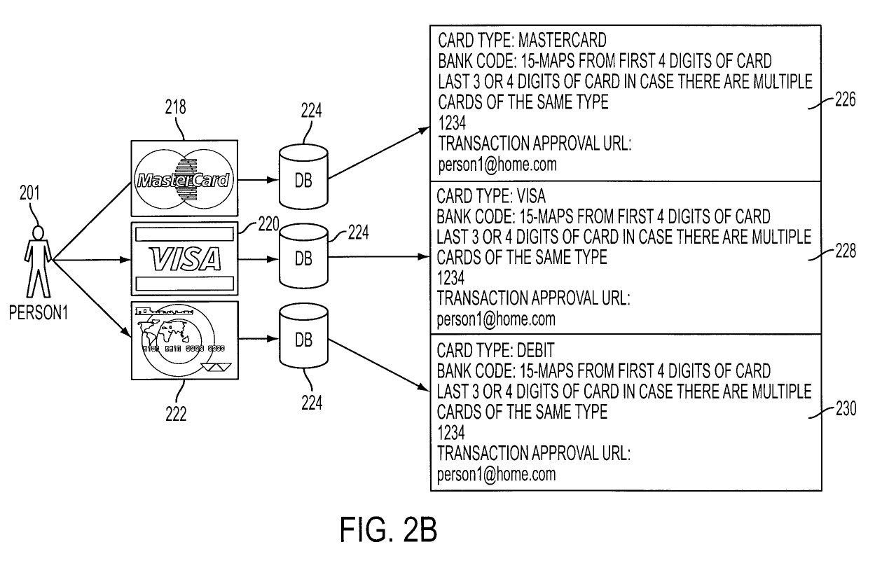

According to exemplary embodiments, the steps a user performs for setting up a trustee database can generally be described in three phases as will now be described with respect to FIGS. 2(a)-2(b). Initially, in the first phase a user 201 submits a list of cards 206 to a trustee database 204. In this example, the list of cards 206 includes a credit card group 208, a debit card group 210, a social insurance item 212, a new service look-up item 214 and a passport item 216, however, more or fewer items can exist in a list of cards 206. In phase two, the user 201 provides the authorization check URI to the desired companies as shown in FIG. 2(b). This authorization check URI is associated with an authorization server (not shown) which can access the database 204, both of which are typically operated by the same hosting service. For example, the user 201 supplies the authorization check URI information to servers associated with card issuers such as MasterCard 218, VISA 220 and a Debit Card 222, each of which stores information in their respective databases (DBs) 224 and forwards the information to their respective automated clearing houses (not shown). Sample information associated with the URI for each separate card is shown in items 226, 228 and 230.

In the third phase, a user 201 sets up group approvals for automatic transaction enabling or blocking as desired. Various types of enabling can be used for these cards, or other items, in the trustee database 204. In a first mode of enabling, the user 201 can identify that a transaction is to occur within a specified time t as well as other related information, such as, the establishment (or business) to make the transaction and a potential maximum cost limit. In a second mode of enabling, the user 201 can identify a window of time, or a time limit, during which the card is open for transactions as well as other related information including, but not limited by, the establishments, limits for each transaction and a maximum limit for the specified time duration. Additionally, geographical restrictions can be specified for each item in the trustee database 204.

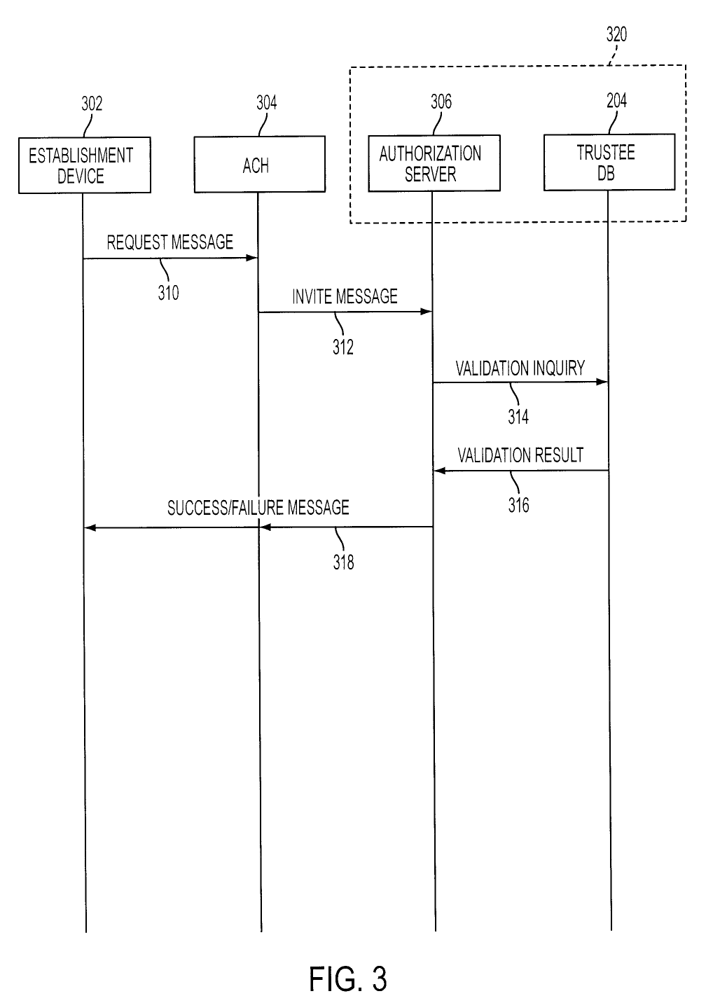

Using the exemplary setup described above, an exemplary embodiment for using a card, e.g., issued by MasterCard 218, at an establishment will now be described with respect to the signaling diagram shown in FIG. 3. Initially, the user 201 uses a card to purchase a product at an establishment, e.g., a person uses their credit card to purchase a personal computer. The establishment uses an establishment device 302, e.g., a credit card swiping device, to temporarily capture and transmit the credit card information as request message 310 to an automated clearing house (ACH) 304. As user herein, the ACH 304 is considered to be the equivalent of an acquiring bank and an issuing bank with the process referring to these entities as acting as a single entity. The ACH 304 uses the information in the request message 310, looks up the field for the authorization URI (which was previously submitted by the user) and contacts the authorization server 306 linked to the URI via an invite message 312, e.g., a SIP INVITE message, as well as other desired parameters of the transaction, e.g., establishment, cost, etc. The authorization server 306 then sends a validation inquiry 314 to a trustee database 204 and looks up whether the credit card can be used for the requested transaction using the previously entered user inputs as described above. In an alternative embodiment, an application server can be used in place of database 204, and in that case the ACH 304 would send a user approval request to the application server. Database 204 could be an XDMS (Extensible Markup Language (XML) Data Management Server (DMS)) database or an alternate database as desired. Additionally, authorization server 306 and database 204 are typically a part of the same hosting service 320 which facilitates the look up mechanism.

Trustee database 204 then returns the validation result 316, including details as to whether the credit card is enabled or disabled, for the requested transaction. Based upon this information, the authorization server 306 transmits a success or failure message 318, e.g., a 200 OK message or a 40x Failure message respectively, along with a transaction digest to the ACH 304 which then forwards the message 318 to the establishment device 302 in the form of a yes approval or a no disapproval response. Depending upon whether a success or failure message is received by the establishment device 302, the requested transaction is approved or disapproved respectively by the establishment.

While the above described exemplary embodiment illustrates an exemplary situation where the item to be referenced is a credit card, similar processes and nodes can be used with any of the other items stored in the trustee database 204, e.g. passports, security codes for buildings, banks or safe deposit boxes, alarms or any other personal information that can be requested which the user has stored in a trustee database, when it needs to be determined if their use has been authorized by the user 201. For example, suppose that a user 201 is going on a business trip to Sweden for a one week period and enables his or her passport for both the geographic location of Sweden as well as the one week time period of travel. The user 201 then loses their passport at the end of their trip. Two week later, someone attempts to use the passport in Malaysia as authentication for a transaction and since the both the time and the location are not enabled the authentication for the transaction fails. Also, in this example, if only one of the two checked items had successfully passed the authentication/authorization check the transaction still would have been rejected.

According to exemplary embodiments, a user 201 can activate or deactivate a card or other item in the trustee database for a transaction through various methods for a transaction. These exemplary methods and systems are described below, and can be also be used in setting up or editing information associated with items in the trustee database, e.g., setting up or modifying profile information for a user 201. According to one exemplary embodiment, information can be transmitted by user 201 through a web browser to the trustee database 204.

According to another, more secure, exemplary embodiment, a Global System for Mobile communications (GSM)/3^{rd} Generation (3G) terminal can be used to submit information to the trustee database 204. From the terminal side, a user 201 can access their data in the trustee database 204 and set the desired tags, e.g., enablement/disablement time, for desired items. To further increase the security the transaction may require a personal identification number (PIN), biometric input, other input, or some combination thereof any of which is known only to the user 201 and the trustee database 204 prior to finalization.

According to an alternative embodiment, from the server side client, dial in tone activated exemplary systems and methods can be used for a user 201 to access the trustee database 204 as desired. In this example, the telephone number is now the URI for use, e.g., a TEL URI. For example, a dial in system can connect to a client that can receive modulated tone signals and decode them to enable or disable a card, or other item in the trustee database 204, from being used. To further improve this system, a continuous set of random tones can be used, so as to prevent someone or something from tracking the handset tone echoes. The user 201 will be able to hear continuous random key tones during the time they have to enter their response for finalizing and/or entering information into the trustee database 204. According to another exemplary embodiment, a SIP client, using, for example, IMS, on the terminal can interact with the user 201 to set the status on the trustee database 204 for modifying/entering data to the trustee database.

As a further security layer for transactions, according to some exemplary embodiments location based transaction authentication can be used, which includes matching the verification terminal's location with the purchasing terminal's location. For example, the user can complete a transaction by entering a personal identification number (PIN), however, according to exemplary embodiments, the PIN is entered only on the user's trusted device, e.g., the user's mobile phone. The location of the mobile phone and the location of the point of sale (POS) terminal can the be checked, so that the authentication of the transaction can be validated based, at least in part, on knowledge that the end user is physically present at the POS for that transaction. Location based transaction authentication is desirable for many reasons including an increased security aspect for the user, reduction of fraudulent expenses which hurt both consumers and businesses, and as a revenue generator for the architecture owners. For example, there are currently over one billion Global System for Mobile communications (GSM) subscribers world wide. These subscribers possess an estimated two billion plus credit and debit cards which are used in approximately five hundred million transactions per day associated with trillions of dollars in annual transaction value (about two percent of which are service fees) and an estimated billion plus dollars in fraud.

All of the charges made by these GSM subscribers are processed over an architecture, e.g., telephone company bitpipes. IMS authentication and authorization based on SIM cards can reduce fraud, reduce identity theft, potentially add billions of dollars in telephone company revenue, reduce subscriber churn, as well as increasing competition against cable suppliers. In support of transaction security, authentication types can be broken down into four segments: (1) user acceptance; (2) location; (3) subscriber identity module (SIM)/Web SIM; and (4) soft/hard token. While each segment or level of authentication provides some security, combining all four segments provides the strongest authentication possible. Using these four segments, authentication policies can be defined and used in support of improving the authentication process.

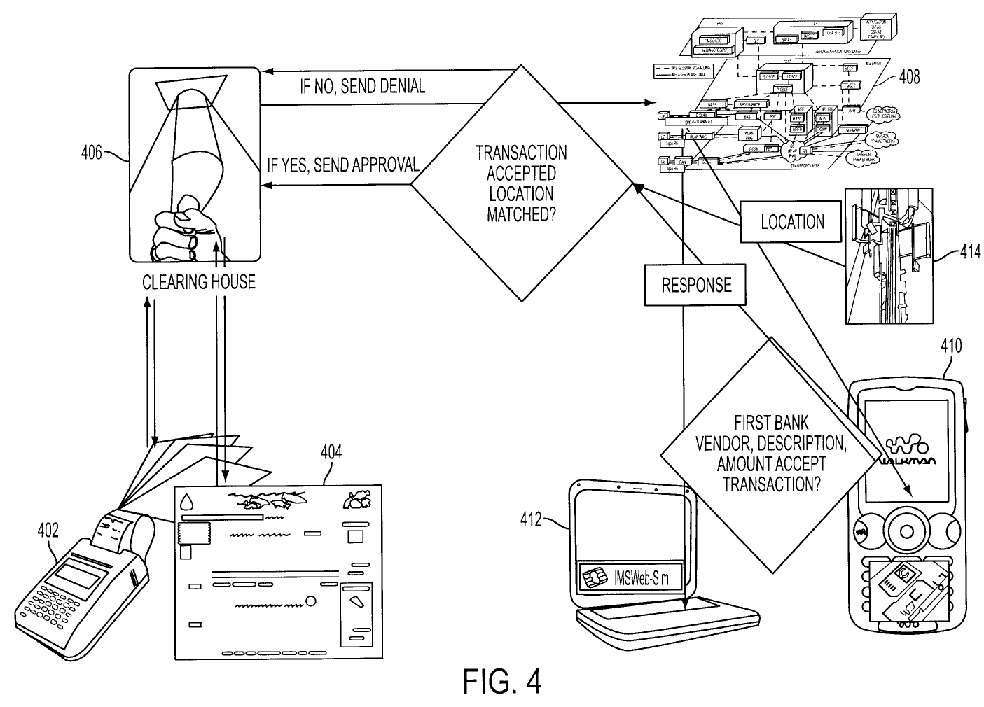

As mentioned above, according to exemplary embodiments, authentication or transaction validation can occur in an IMS architecture which is illustrated in FIG. 1. This IMS authentication and authorization can use a SIM card which is attached to an end user's mobile phone or other device to be used for transaction authorization. For example, in an exemplary method shown in FIG. 4, every transaction is authenticated via IMS using the SIM or Web SIM as a trusted device. The POS terminal 402, automatic teller machine (ATM) (not shown) or web application 404 starts a charge transaction. The transaction is then transferred to a clearing house 406, e.g., an ACH, or a bank. The clearing house 406 looks up the private banking URI and contacts the SIM attached to the mobile device 410 or Web SIM based device 412 preferably over an IMS architecture 408. The user is then asked to validate the transaction based on the SIM and the location, i.e., the user 201 is only asked to validate the transaction if the mobile device 410's location is relatively the same as that of the POS terminal 402, e.g., within a predetermined distance. The user accepts or declines the transaction and signs by, for example, entering their PIN. The transaction is then complete, for which the IMS provider can receive a percentage of the transaction, e.g., 0.05% of the transaction amount.

In support of exemplary embodiments which use an IMS architecture, new nodes/functions (or new functions on currently existing IMS nodes as shown in FIG. 1 or a presence server) can be introduced into the current IMS architecture. More particularly, the nodes/functions of an identity server, a user policy and a transaction log server can be provided in support of exemplary embodiments could reside on one or more ASs (10). The identity server, which can also perform the functions of the authorization server 306 described above according to exemplary embodiments, verifies user identify with the four levels of authentication, receives transaction approval and identity requests, receives/retrieves responses and transmits authentication status in return. Additionally, the identity server manages denial of service (DOS) issues as well as random calling/irritant attacks. The user policy can set policies for SIM based transactions for location, price, friends and family as well as perform sub-licensing to other phones and Web SIMs. The transaction log server keeps track of all transactions for forensic purposes, e.g., for future reference as needed.

One challenge associated with location based transaction authentication according to exemplary embodiments involves identifying the POS terminal 402, as many POS terminals are hidden by a firewall and, as such, there is currently no method available to identify these POS terminals uniquely. Accordingly to exemplary embodiments, one solution is to allow each POS terminal 402 to have a unique method of identification as described below.

According to exemplary embodiments, creating a unique identification for a POS terminal 402 includes providing the following information for each POS terminal: the device type; the connection method; and a public encryption key pair. Device type can be broken down into two categories, fixed POS, e.g., a cash register, or non-fixed POS, e.g., a web browser or a swipe reader. The connection method describes the method used to connect the device to the ACH and can be, for example, either a dial-up if the location data of the POS terminal 402 from a telephone company is used, or if it is a broadband connection, the link (virtual circuit) that connects to the reader is identified and used. This process can be performed for all POS servicing links identified ahead of time to eliminate the delays in processing a transaction. Fixed readers may need to do this only once, while mobile terminals or non-fixed devices may need to execute this process every time that they register on a new link. The third part of the unique identification for a POS terminal 402 according to exemplary embodiments is a public encryption key pair, one for each reader and one for the ACH. A unique identification for a POS terminal 402 may look like the following:

UniqueID =Terminal URI+IP Address+MAC Address+Telephone Number (if dial up)+Broadband connection point (e.g., Ericsson EDA Address)+Vendor ID (and location)

It is to be understood, that this UniqueID is purely illustrative, and that various combinations of the above listed fields as well as other similar information may be used to create a unique identification for a POS terminal 402.

When a transaction is sent to the ACH, the ACH will challenge the terminal to identify itself by using the terminal's public key to encrypt a handshake message with the reader's public key and to send it to the reader. The reader then responds by decrypting the message using its private key, and sending back the ACH handshake message encrypted with the ACH public key. If the ACH is able to decode the handshake message using its private key, then the reader is identified. These messages are sent on the links previously setup, e.g., the virtual circuit used in a broadband connection, and typically are not routed using an alternate path. Once the reader is identified, the physical location of the POS terminal 402 can be referenced based on the link information, e.g., the physical location of the POS terminal 402 can be retrieved from a database which stores POS terminal 402 physical locations indexed by unique POS terminal 402 IDs. The physical location of the POS terminal 402 can then be correlated with the location of the mobile phone to ensure that they match.

The location of the mobile phone is identified by querying a node, e.g., the Gateway General Packet Radio Service (GPRS) Support Node (GGSN), for location information. More specifically, the approximate position of the user's mobile device within a cell can be compared to the known position of the POS terminal and based upon there overlap or closeness location can be confirmed or determined to be different. However, depending upon the type of mobile communications network the mobile phone is currently attached to, different nodes could provide the location information. Additionally, this information can be matched to information stored in the trustee database 204 which would be used to verify that the transaction is taking place in an enabled geographic location for either the mobile phone or a credit card (or whichever piece of personal information is being used in this transaction).

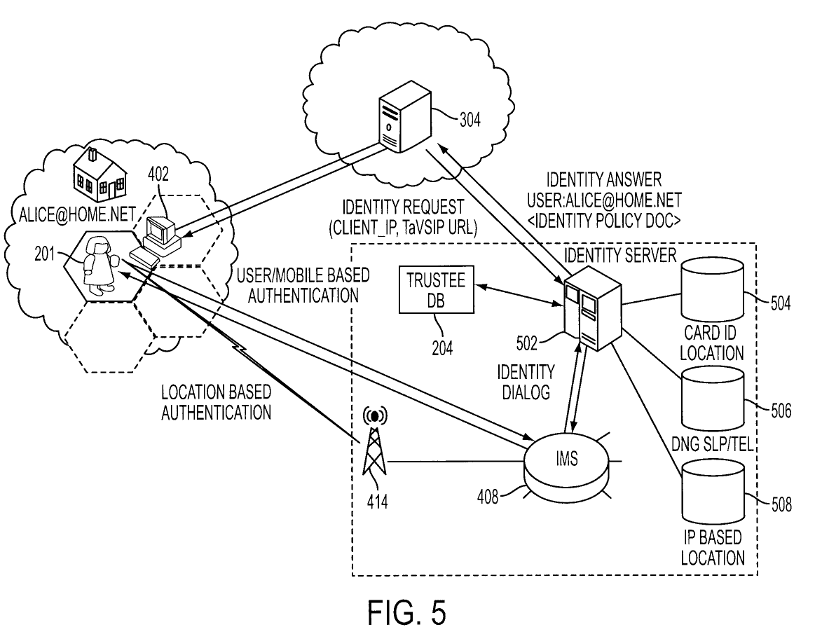

Using the above described exemplary embodiments, an example of performing a secure transaction including location verification will now be described with respect to FIG. 5. Initially a user 201 has input a variety of personal information, including credit card information, into a trustee database 204. At some future point in time, the user 201 then decides to make an online transaction using a web browser 412 which acts as a POS terminal. The transaction is sent to the ACH 304 which in turn looks up the user supplied URI and uses the URI to query, e.g., transmit an identity request message as a SIP INVITE message, the identity server 502 (which also acts as an authorization server). The identity server 502 verifies with the trustee database 204 that the referenced credit card is enabled for this transaction. Additionally, the identity server identifies/authenticates the user 201 by using all four of the above described authentication segments.

Communicating over a network, e.g., an IMS network 408, the identity server 502 requests user acceptance by, for example, requesting a PIN number. Additionally, the identity server 502 verifies location, communicates with the SIM associated with the user's mobile phone, and receives a soft/hard token. To determine the location of the user 201 through their mobile phone, the identity server through the IMS network 408 communicates with the cell/base station 414 (or potentially the GGSN) which provides the location information of the mobile phone. For location of the POS terminal 402, information is gathered from the link and compared with other available information from various sources, e.g., cell ID information sources 504, domain name server(s) 506 and IP based location sources 508. The location of the POS terminal 402 is then compared with the location of the user 201 and if the locations are acceptably close, assuming all other authorization requirements have passed, the transaction is approved. This approval information is then transmitted back to the POS terminal 402 through the ACH 304 as a message, e.g., 200 SIP OK message.

According to other exemplary embodiments, additional functions can be provided to create more benefits to exemplary embodiments the present invention, particularly to prevent hijacking and/or kidnapping. For example, in a situation where the end user 201 is being held hostage to complete a transaction, e.g., a user 201 is being forced to use a credit card to retrieve cash at an automatic teller machine, the user 201 can enter their PIN in its reverse sequence. This allows the desired transaction to occur, but also can trigger additional actions as described below.

According to exemplary embodiments, these additional actions can include generating an emergency message to the police or other appropriate authorities. This can be followed by triggering security cameras in the area to switch from a lapse mode to a live mode which enables timely video of the site to be captured. This video can then be sent as live feeds to the authorities. Finally, as the individual(s) begin to move, cameras in the path of motion can be switched to a live mode to give authorities live information regarding the status of the user 201, as well as other information to support their decision making process.

According to another exemplary embodiment, when an end user 201 has left behind his or her mobile phone, authorization can still occur for a transaction. In the case of the left behind phone (or when a user 201 is unable to use their phone, e.g., out of service coverage or the mobile phone battery is depleted), a user 201 can have a one-time, or single use, PIN which can be used at the POS by the user. When this occurs, the user 201 enters the one-time PIN to approve the transaction which bypasses the need for authorization using their mobile phone as part of the validation process. When the user's phone has been found, powered up again or is back in service coverage, a new one time PIN can be generated and sent to the user 201. This provides emergency access to a transaction when the normal process would not work. Also for additional security, in the event of a lost phone, a toll free number or URI can be accessed through which the user identifies themselves which shuts down the mobile phone from further use, potentially preventing unauthorized users from making transactions

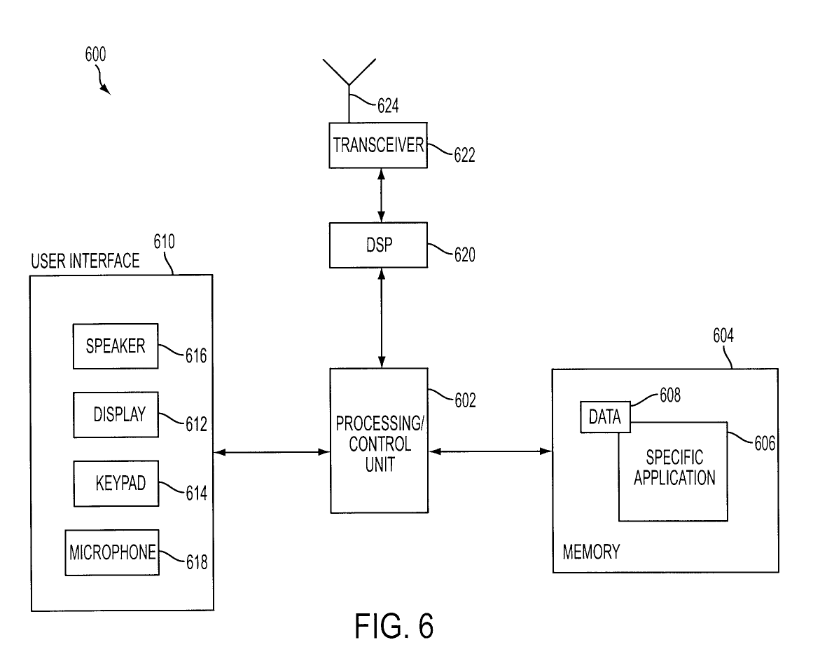

For purposes of illustration and not of limitation, an example of a representative mobile terminal computing system capable of carrying out operations in accordance with the exemplary embodiments is illustrated in FIG. 6. It should be recognized, however, that the principles of the present exemplary embodiments are equally applicable to standard computing systems. Additionally, this representative mobile terminal computing system could be used either by the user 201 to set up information with respect to the trustee database and providing URI information to entities as desired, but also as an authorization requesting device from an establishment which could allow a user to perform onsite enablement of an item in their trustee database as desired.

The exemplary mobile computing arrangement 600 may include a processing/control unit 602, such as a microprocessor, reduced instruction set computer (RISC), or other central processing module. The processing unit 602 need not be a single device, and may include one or more processors. For example, the processing unit 602 may include a master processor and associated slave processors coupled to communicate with the master processor.

The processing unit 602 may control the basic functions of the mobile terminal as dictated by programs available in the storage/memory 604. Thus, the processing unit 602 may execute the functions associated with a mobile terminal as described with respect to FIGS. 2(a)-5. More particularly, the storage/memory 604 may include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the mobile computing arrangement 600 via data signals, such as being downloaded electronically via a network, such as the Internet.

One of the programs that may be stored in the storage/memory 604 is a specific program 606. The specific program 606 may interact with a trustee database to edit information and/or assist in the above described security features. The program 606 and associated features may be implemented in software and/or firmware operable by way of the processor 602. The program storage/memory 604 may also be used to store data 608, such as the various authentication rules, or other data associated with the present exemplary embodiments. In one exemplary embodiment, the programs 606 and data 608 are stored in non-volatile electrically-erasable, programmable ROM (EEPROM), flash ROM, etc. so that the information is not lost upon power down of the mobile terminal 600.

The processor 602 may also be coupled to user interface 610 elements associated with the mobile terminal. The user interface 610 of the mobile terminal may include, for example, a display 612 such as a liquid crystal display, a keypad 614, speaker 616, and a microphone 618. These and other user interface components are coupled to the processor 602 as is known in the art. The keypad 614 may include alpha-numeric keys for performing a variety of functions, including dialing numbers and executing operations assigned to one or more keys. Alternatively, other user interface mechanisms may be employed, such as voice commands, switches, touch pad/screen, graphical user interface using a pointing device, trackball, joystick, or any other user interface mechanism.

The mobile computing arrangement 600 may also include a digital signal processor (DSP) 620. The DSP 620 may perform a variety of functions, including analog-to-digital (A/D) conversion, digital-to-analog (D/A) conversion, speech coding/decoding, encryption/decryption, error detection and correction, bit stream translation, filtering, etc. The transceiver 622, generally coupled to an antenna 624, may transmit and receive the radio signals associated with a wireless device. Additionally, the mobile computing arrangement 600 may also include a magnetic card reader (not shown) or a biometric input device (not shown), e.g., a finger scanner.

The mobile computing arrangement 600 of FIG. 6 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. For example, the specific application 606 and associated features, and data 608, may be stored in a variety of manners, may be operable on a variety of processing devices, and may be operable in mobile devices having additional, fewer, or different supporting circuitry and user interface mechanisms.

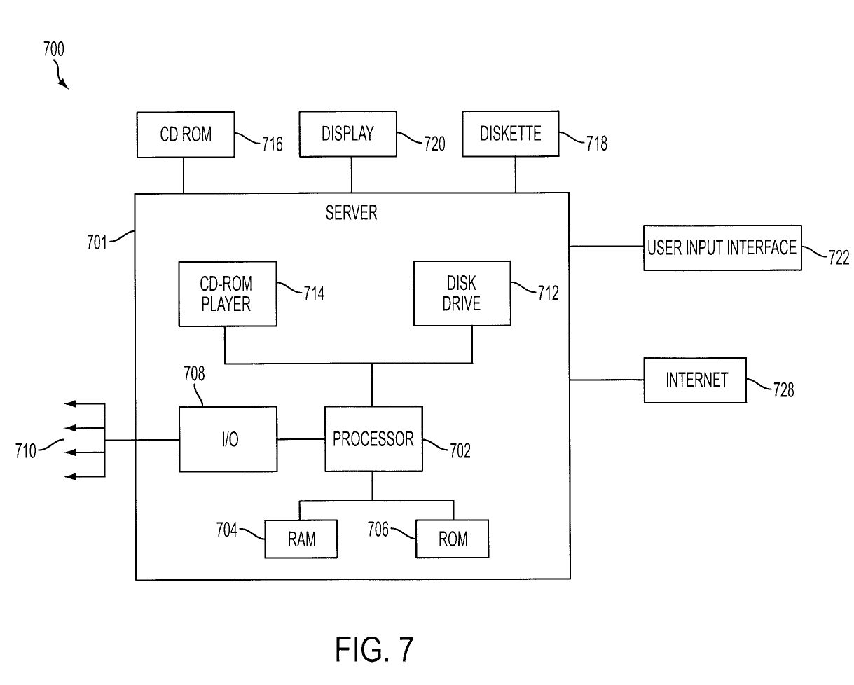

The trustee database or other systems for providing personal information in connection with the present exemplary embodiments may be any type of computing device capable of processing and communicating presence information. An example of a representative computing system capable of carrying out operations in accordance with the servers (and IMS nodes) of the exemplary embodiments is illustrated in FIG. 7. Hardware, firmware, software or a combination thereof may be used to perform the various steps and operations described herein. The computing structure 700 of FIG. 7 is an exemplary computing structure that may be used in connection with such a system.

The exemplary computing arrangement 700 suitable for performing the activities described in the exemplary embodiments may include server 701, which may correspond to the application server 10, trustee database 204, identity server 502, authorization server 306 or be in communication/control of the trustee database 204. Such a server 701 may include a central processor (CPU) 702 coupled to a random access memory (RAM) 704 and to a read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. The processor 702 carries out a variety of functions as is known in the art, as dictated by software and/or firmware instructions.

The server 701 may also include one or more data storage devices, including hard and floppy disk drives 712, CD-ROM drives 714, and other hardware capable of reading and/or storing information such as DVD, etc. In one embodiment, software for carrying out the above discussed steps may be stored and distributed on a CD-ROM 716, diskette 718 or other form of media capable of portably storing information. These storage media may be inserted into, and read by, devices such as the CD-ROM drive 714, the disk drive 712, etc. The server 701 may be coupled to a display 720, which may be any type of known display or presentation screen, such as LCD displays, plasma display, cathode ray tubes (CRT), etc. A user input interface 722 is provided, including one or more user interface mechanisms such as a mouse, keyboard, microphone, touch pad, touch screen, voice-recognition system, etc.

The server 701 may be coupled to other computing devices, such as the landline and/or wireless terminals and associated watcher applications, via a network. The server may be part of a larger network configuration as in a global area network (GAN) such as the Internet 728, which allows ultimate connection to the various landline and/or mobile client/devices.

The above described exemplary embodiments describe systems and methods for both protecting a user's personal information that needs to be accessed for a variety of potential transactions and performing secure transactions themselves. Advantages of the present invention include, but are not limited to, allowing the end user to have full control as to when personal documents and data are available for use. This eliminates the fraudulent use of cards and personal data without the knowledge of the individual or business. Additionally, exemplary embodiments of the present invention can be used in an IMS environment, as well as other networking environments. These advantages are described in more detail below.

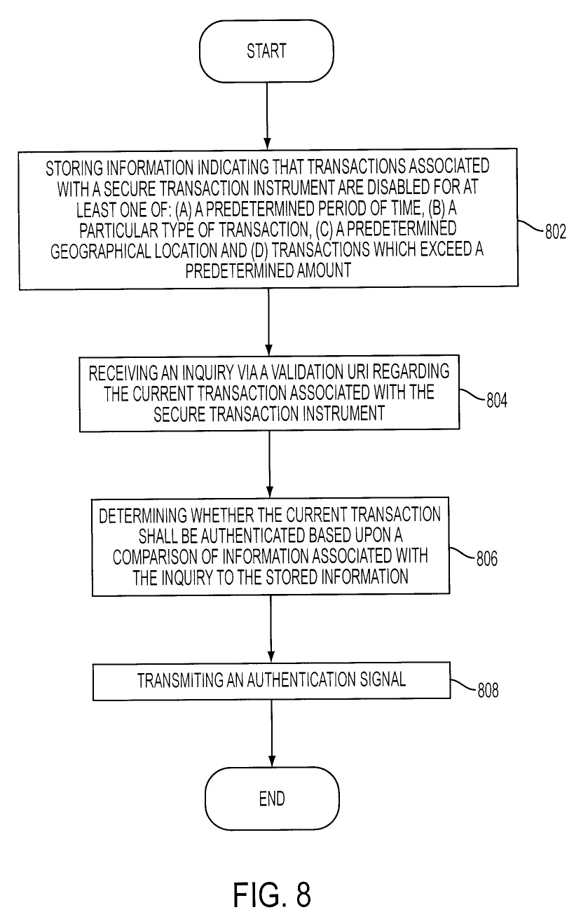

Utilizing the above-described exemplary embodiments, an exemplary method for validating a transaction is shown in the flowchart of FIG. 8. Initially a method for validating a current transaction includes: storing information indicating that transactions associated with a secure transaction instrument are disabled for at least one of: (a) a predetermined period of time, (b) a particular type of transaction, (c) a predetermined geographical location and (d) transactions which exceed a predetermined amount in step 802; receiving an inquiry via a validation Uniform Resource Identifier (URI) regarding the current transaction associated with the secure transaction instrument in step 804; determining whether the current transaction shall be authenticated based upon a comparison of information associated with the inquiry to the stored information in step 806; and transmitting an authentication signal in step 808.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

Modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method for validating a current transaction comprising:
storing information indicating that transactions associated with a secure transaction instrument are disabled for at least one of: (a) a predetermined period of time, (b) a particular type of transaction, (c) a predetermined geographical location and (d) transactions which exceed a predetermined amount;
receiving an inquiry via a validation Uniform Resource Identifier (URI) regarding said current transaction associated with said secure transaction instrument;
determining whether said current transaction shall be authenticated based upon a comparison of information associated with said inquiry to said stored information; and
transmitting an authentication signal.

2. The method of claim 1, wherein said inquiry includes information associated with both said current transaction and a point of sale (POS) terminal, said method further comprising:
identifying said POS terminal using said information and determining a first location of said POS terminal based upon said identification;
identifying a user based upon said information, and determining a second location of an end user device associated with said user; and
selectively authenticating said transaction based, at least in part, on said first and second locations.

3. The method of claim 2, wherein said step of identifying said POS terminal further comprises:
identifying said POS terminal based upon a device type, a connection type and a public encryption key pair associated with said POS terminal.

4. The method of claim 2, wherein said step of selectively authenticating said transaction further comprises:
verifying that said end user device is generally co-located with said POS terminal;
communicating with a subscriber identity module (SIM) or a web SIM associated with said mobile system; and
receiving a soft/hard token.

5. The method of claim 1, wherein said method for validating a current transaction can be performed over an Internet Protocol Multimedia Subsystem (IMS) environment.

6. The method of claim 1, further comprising;
requiring the receipt of a personal identification number (PIN) to authorize said transaction.

7. The method of claim 1, wherein said information indicating that transactions associated with a secure transaction instrument are disabled for a predetermined period of time.

8. The method of claim 1, wherein said information indicating that transactions associated with a secure transaction instrument are disabled for a particular type of transaction.

9. The method of claim 1, wherein said information indicating that transactions associated with a secure transaction instrument are disabled for a predetermined geographical location.

10. The method of claim 1, wherein said information indicating that transactions associated with a secure transaction instrument are disabled for transactions which exceed a predetermined amount.

11. The method of claim 1, wherein information indicating that transactions associated with a secure transaction instrument are disabled undergoes a first encryption into an encrypted string, further wherein said encrypted string undergoes a second encryption generating a constant.

12. The method of claim 11, wherein a first mechanism for performing said first encryption is stored in a first location and a second mechanism for performing said second encryption is stored in a second location which is different from said first location.

13. The method of claim 6, wherein if said PIN is entered in reverse order an emergency message to authorities is generated and cameras near said secure transaction instrument are triggered to switch to a live feed mode.

14. A device for validating a current transaction comprising:
a memory for storing information indicating that transactions associated with a secure transaction instrument are disabled for at least one of: (a) a predetermined period of time, (b) a particular type of transaction, (c) a predetermined geographical location and (d) transactions which exceed a predetermined amount;
an input circuitry for receiving an inquiry via a validation Uniform Resource Identifier (URI) regarding said current transaction associated with said secure transaction instrument;
a processor for determining whether said current transaction shall be authenticated based upon a comparison of information associated with said inquiry to said stored information; and
an output circuitry for transmitting an authentication signal.

15. The device of claim 14, wherein said inquiry includes information associated with both said current transaction and a point of sale (POS) terminal, further wherein said processor performs the steps of:
identifying said POS terminal using said information and determining a first location of said POS terminal based upon said identification;
identifying a user based upon said information, and determining a second location of an end user device associated with said user; and
selectively authenticating said transaction based, at least in part, on said first and second locations.

16. The device of claim 15, wherein said processor further performs the step of:
identifying said POS terminal based upon a device type, a connection type and a public encryption key pair associated with said POS terminal.

17. The device of claim 15, wherein said device performs the steps of:
verifying that said end user device is generally co-located with said POS terminal;
communicating with a subscriber identity module (SIM) or a web SIM associated with said mobile system; and
receiving a soft/hard token.

18. The device of claim 14, wherein said device for validating a current transaction can interact with an Internet Protocol Multimedia Subsystem (IMS) environment.

19. The device of claim 14, wherein said device requires the receipt of a personal identification number (PIN) to authorize said transaction.

20. The device of claim 14, wherein said information indicating that transactions associated with a secure transaction instrument are disabled for a predetermined period of time.

21. The device of claim 14, wherein said information indicating that transactions associated with a secure transaction instrument are disabled for a particular type of transaction.

22. The device of claim 14, wherein said information indicating that transactions associated with a secure transaction instrument are disabled for a predetermined geographical location.

23. The device of claim 14, wherein said information indicating that transactions associated with a secure transaction instrument are disabled for transactions which exceed a predetermined amount.

24. The device of claim 14, wherein information indicating that transactions associated with a secure transaction instrument are disabled undergoes a first encryption into an encrypted string, further wherein said encrypted string undergoes a second encryption generating a constant.

25. The device of claim 24, wherein a first mechanism for performing said first encryption is stored in a first location and a second mechanism for performing said second encryption is stored in a second location which is different from said first location.

26. The device of claim 19, wherein if said PIN is entered in reverse order an emergency message to authorities is generated and cameras near said secure transaction instrument are triggered to switch to a live feed mode.

27. A method for establishing validation parameters for a secure transaction instrument comprising:
transmitting, from an end user device, information indicating that said secure transaction instrument shall be disabled for at least one of: (a) a predetermined period of time, (b) a particular type of transaction to a trustee database server, (c) a predetermined geographical location and (d) transactions which exceed a predetermined amount.

28. The method of claim 27, further comprising:
receiving, at said trustee database server, said information;
storing said information; and
using said information to validate subsequent transactions associated with said secure transaction instrument.

29. The method of claim 28, wherein said information is associated with said end user's credit card.

30. The method of claim 29, wherein said information includes end user, a last three digits from said credit card and an issuing bank name.

31. The method of claim 28, wherein said information is associated with said end user's passport.

32. The method of claim 27, further comprising:
receiving random mixed number tones at shifted timings at said end user device when entering said information.

33. A device for establishing validation parameters for a secure transaction instrument comprising:
an output circuitry for transmitting, from an end user device, information indicating that said secure transaction instrument shall be disabled for at least one of: (a) a predetermined period of time, (b) a particular type of transaction to a trustee database server, (c) a predetermined geographical location, and (d) transactions which exceed a predetermined amount.

34. The device of claim 33, further comprising:
an input circuitry for receiving, at said trustee database server, said information;
a memory for storing said information; and
a processor for using said information to validate subsequent transactions associated with said secure transaction instrument.

35. The device of claim 34, wherein said information is associated with said end user's credit card.

36. The device of claim 35, wherein said information includes end user, a last three digits from said credit card and an issuing bank name.

37. The device of claim 34, wherein said information is associated with said end user's passport.

38. The method of claim 33, wherein said input circuitry receives random mixed number tones at shifted timings when entering said information.
